(19) United States
(12) Patent Application Publication
(10) Pub. No.: US 2025/0382823 A1
(43) Pub. Date: Dec. 18, 2025

(54) Building Element Driving and Pulling Device

(71) Applicant: Daryl Gatt, Capalaba (AU)

(72) Inventor: Daryl Gatt, Capalaba (AU)

(21) Appl. No.: 18/741,286

(22) Filed: Jun. 12, 2024

(51) Int. Cl. E04H 17/26; B25D 1/16

(52) U.S. Cl. CPC E04H 17/263; B25D 1/16; E04H 17/265

(57) ABSTRACT

A building element driving and pulling device includes an elongated guide frame defining a guide channel, a drive stop positioned at a first end of the guide channel and a pull stop positioned at a second end of the guide channel, a locking assembly, and a slide hammer. The drive stop includes a receptacle designed to receive a portion of a building element therein. The locking assembly is designed to releasably lock a portion of a building element in the drive stop. The slide hammer is positioned within the guide frame and manually slidable along the guide channel between the drive stop and the pull stop and to selectively engage the drive stop to drive a building element into a material and the pull stop to pull a building element out of a material.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION (1) Field of the Invention

The disclosure relates to post driving and pulling devices and more particularly pertains to a new building element driving and pulling device for providing a user with an easier way to both drive and pull building elements, such as solid rods, rebar, star pickets, and other similar elongated structures, using a single tool that provides both a continuous pressing force and an intermittent striking force.

### (2) Description of Related Art including information disclosed under 37 CFR 1.97 and 1.98

The prior art relates to post driving and pulling devices. The prior art, as best understood, does not disclose a post driver and puller comprising a slide hammer apparatus that is configured to fit over a picket or post, wherein the hammer apparatus includes a securing mechanism near the bottom that has a threaded screw fastener. The securing mechanism locks onto a portion of the post and the slide hammer is forced in the upward direction to pull the post from the ground.

### BRIEF SUMMARY OF THE INVENTION

An embodiment of the disclosure meets the needs presented above in a building element driving and pulling device generally comprising an elongated guide frame defining a guide channel, a drive stop positioned at a first end of the guide channel and a pull stop positioned at a second end of the guide channel, a locking assembly, and a slide hammer. The drive stop includes a receptacle designed to receive a portion of a building element therein. The locking assembly is designed to releasably lock a portion of a building element in the drive stop. The slide hammer is positioned within the guide frame and manually slidable along the guide channel between the drive stop and the pull stop and to selectively engage the drive stop to drive a building element into a material and the pull stop to pull a building element out of a material.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a building element driving and pulling device according to an embodiment of the disclosure.

FIG. 2 is a top view of an embodiment of the disclosure.

FIG. 3 is a side view of an embodiment of the disclosure.

FIG. 4 is a side view of an embodiment of the disclosure.

FIG. 5 is a back view of an embodiment of the disclosure.

FIG. 6 is a perspective view of an embodiment of the disclosure in use with a star picket.

FIG. 7 is a perspective view of an embodiment of the disclosure in use with a star picket.

FIG. 8 is a perspective view of an embodiment of the disclosure in use with a star picket.

FIG. 9 is a perspective view of an embodiment of the disclosure in use with a solid rod.

FIG. 10 is a perspective view of an embodiment of the disclosure in use with a solid rod.

FIG. 11 is a perspective view of an embodiment of the disclosure in use with a solid rod.

### DETAILED DESCRIPTION OF THE INVENTION

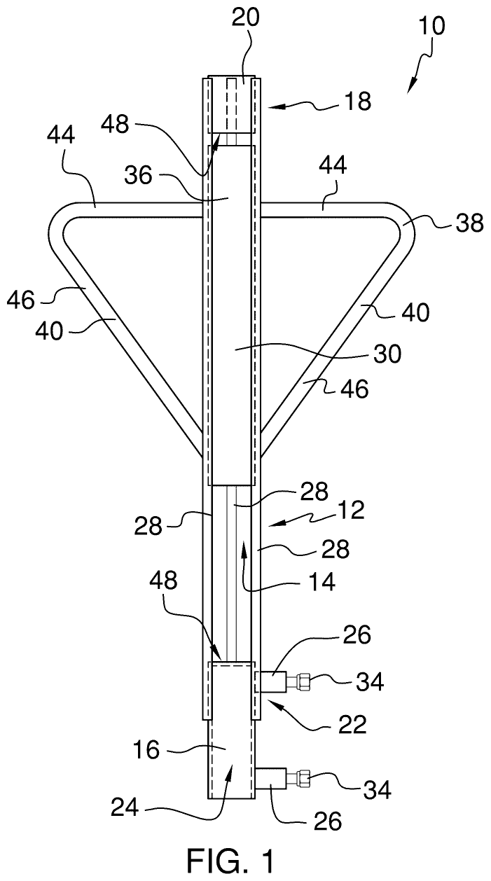

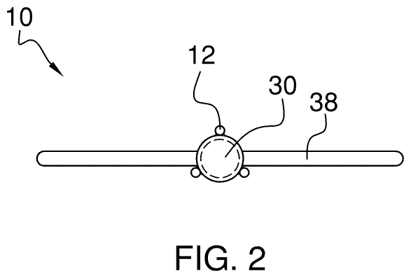

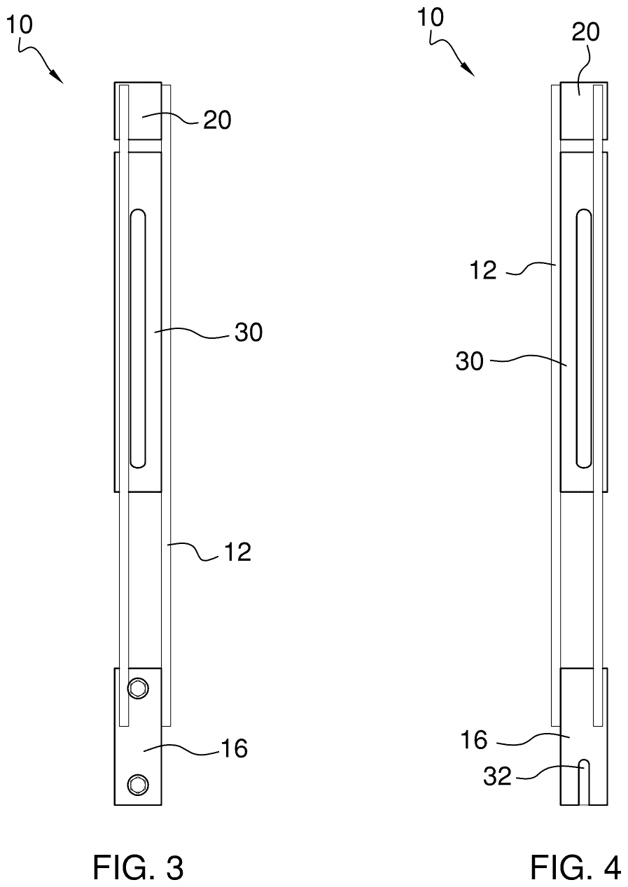

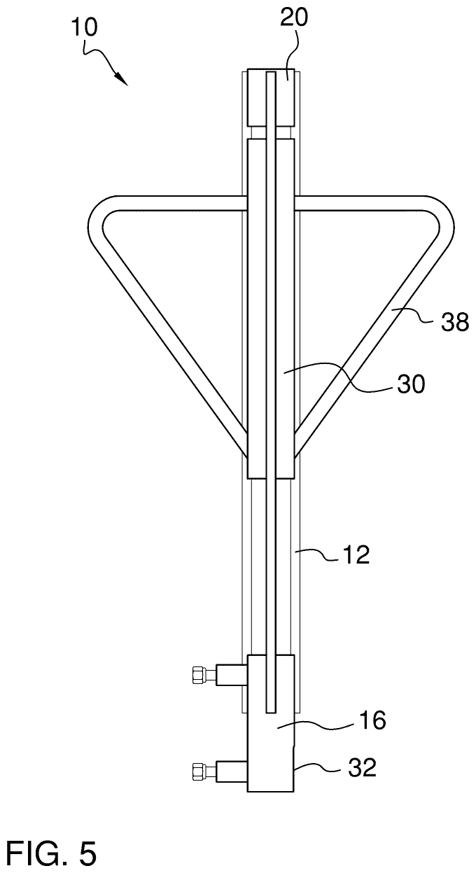

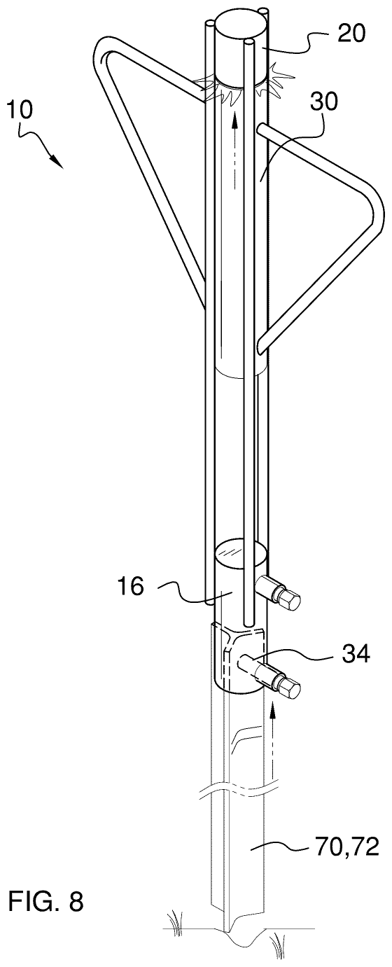

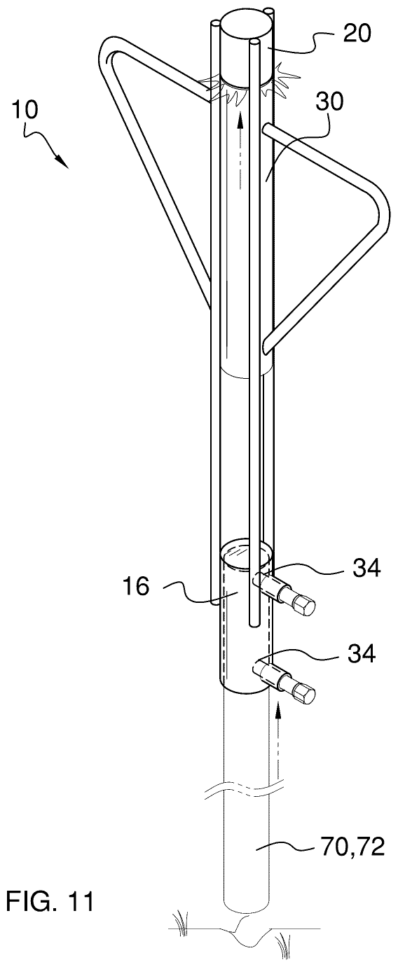

With reference now to the drawings, and in particular to FIGS. 1 through 11 thereof, a new building element driving and pulling device embodying the principles and concepts of an embodiment of the disclosure and generally designated by the reference numeral 10 will be described.

As best illustrated in FIGS. 1 through 11, the building element driving and pulling device 10 generally comprises an elongated guide frame 12 defining a guide channel 14, a drive stop 16 positioned at a first end 18 of the guide channel 14 and a pull stop 20 positioned at a second end 22 of the guide channel 14, a locking assembly 26, and a slide hammer 30. The drive stop 16 includes a receptacle 24 designed to receive a portion of a building element therein. The locking assembly 26 is designed to releasably lock a portion of a building element in the drive stop 16. The slide hammer 30 is positioned within the guide frame 12 and manually slidable along the guide channel 14 between the drive stop 16 and the pull stop 20 and to selectively engage the drive stop 16 to drive a building element into a material, such as the ground or other material, and the pull stop 20 to pull a building element out of a material.

As shown in the exemplary embodiment in FIG. 1, the guide frame 12 includes a plurality of wire frame pieces 28 positioned parallel to each other and spaced apart at intervals. Other designs are within the scope of the disclosure. Each of the drive stop 16 and the pull stop 20 includes a strike face 48 positioned to face toward one another. Each of the drive stop 16 and the pull stop 20 includes a substantially cylindrical structure mounted to and within the guide frame 12, though other shapes such as square or triangular are within the scope of the disclosure. In the exemplary embodiment shown in FIG. 4, the drive stop 16 includes at least one guide slot 32 designed to receive and engage with at least one fin of a star picket. While only one guide slot 32 is shown in FIG. 4, two or three or more guide slots 32 could be included in one possible embodiment, to further increase engagement of the drive stop 16 with a star picket. In the exemplary embodiment in FIG. 1, the locking assembly 26 includes adjustable locking bolts 34 designed to be axially moved into locking engagement with a building element in the drive stop 16. However, other designs, such as spring-loaded lock pins or screws, could be utilized.

The slide hammer 30 includes an elongated drive body 36 and a handle 38 projecting out through the guide frame 12. In the exemplary embodiment in FIG. 1, the handle 38 includes a pair of handle portions 40 projecting from the drive body 36, though fewer or more handle portions 40 could be included in one possible embodiment. Each of the handle portions 40 shown in the exemplary embodiment includes a substantially V-shaped rod 42 having a first rod portion 44 projecting radially from a first portion of the drive body 36 and a second rod portion 46 projecting at an angle from a second portion of the drive body 36. The positioning of the first rod portion 44 and the second rod portion 46 allow for different gripping angles and positions.

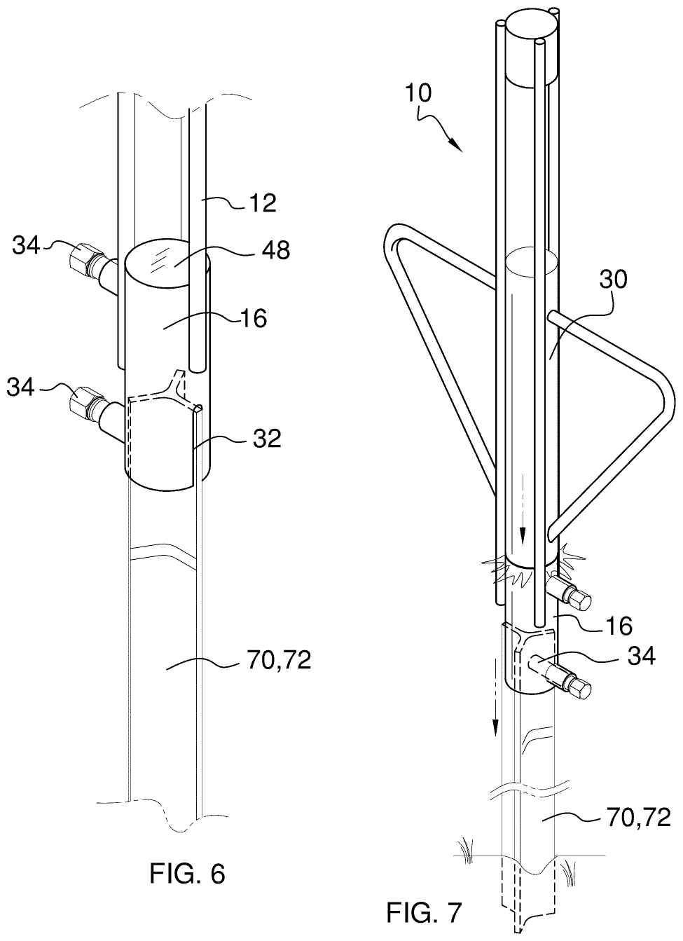

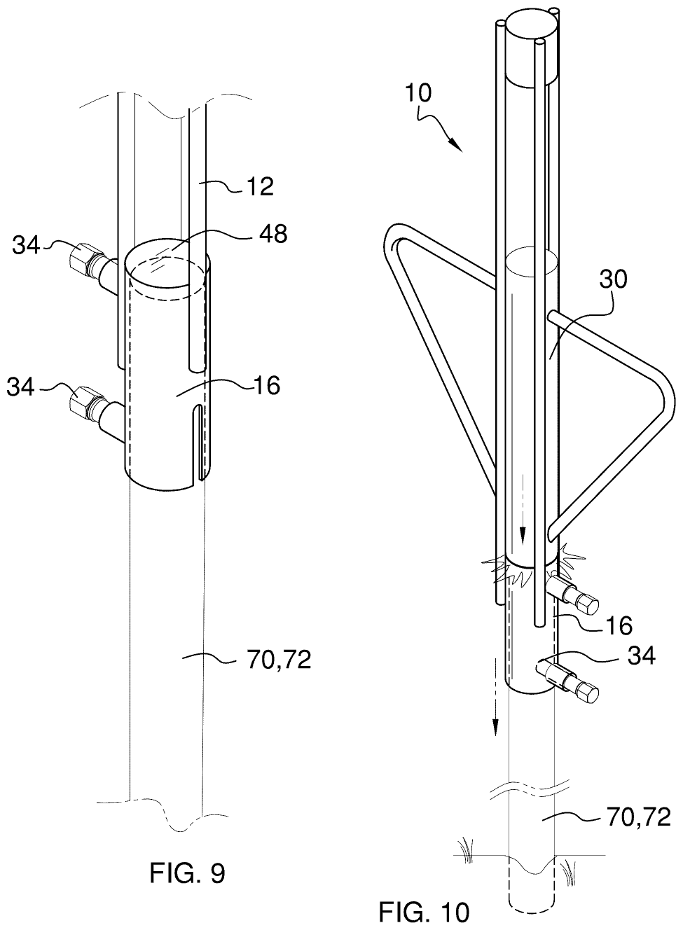

The building element driving and pulling device 10 is used to both drive and pull building elements 70, such as star pickets 72 with fins or solid rods 74 like rebar, into and out of materials in which the building element 70 is to be embedded or is presently embedded. In a driving process, the user places a portion of a building element 70, such as a star picket 72 as shown in FIGS. 6 through 8 or a solid rod 74 as shown in FIGS. 9 through 11, into the receptacle 24 of the drive stop 16. For the driving process only, the user can optionally adjust the locking assembly 26 and releasably lock the building element 70 in the receptacle 24, though this is not required. The user then positions the building element 70 above the material, such as the ground, into which the building element 70 is to be driven. The user then grips the handle 38s and manually slides the slide hammer 30 along the guide channel 14 and engages the drive stop 16 and drives the building element 70 into the ground or other material. The user can use the slide hammer 30 to either press against or strike the strike face 48 of the drive stop 16. Once the building element 70 is driven to a sufficient depth, the user removes the building element driving and pulling device 10. In a pulling process, the user places the portion of the building element 70 into the receptacle 24. For the pulling process, the user must adjust the locking assembly 26 and releasably lock the building element 70 in the receptacle 24. The user then grips the handles 38 and manually slides the slide hammer 30 along the guide channel 14 and engages the pull stop 20 and pulls the building element 70 out of the ground or other material. As with the drive stop 16, the user can use the slide hammer 30 to either press against or strike the strike face 48 of the pull stop 20. Once the building element 70 is extracted, the user removes adjusts the locking assembly 26 and releases the building element 70 from the receptacle 24. Due to the slidable design of the slide hammer 30, the user can employ both the increased force provided by striking the drive stop 16 and the pull stop 20 and the controlled force provided by pressing the slide hammer 30 continuously against the drive stop 16 and the pull stop 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A building element driving and pulling device comprising:
an elongated guide frame defining a guide channel;
a drive stop disposed at a first end of said guide channel and a pull stop disposed at a second end of said guide channel, wherein said drive stop comprises a receptacle configured to receive a portion of a building element therein;
a locking assembly configured to releasably lock a portion of a building element in said drive stop; and
a slide hammer disposed within said guide frame and manually slidable along said guide channel between said drive stop and said pull stop and to selectively engage said drive stop to drive a building element into a material and said pull stop to pull a building element out of a material.

2. The building element driving and pulling device of claim 1, wherein said guide frame comprises a plurality of wire frame pieces disposed parallel to each other and spaced apart at intervals.

3. The building element driving and pulling device of claim 1, wherein each of said drive stop and said pull stop comprises a strike face disposed to face toward one another.

4. The building element driving and pulling device of claim 1, wherein each of said drive stop and said pull stop comprises a substantially cylindrical structure mounted to and within said guide frame.

5. The building element driving and pulling device of claim 1, wherein said drive stop comprises at least one guide slot configured to receive and engage with at least one fin of a star picket.

6. The building element driving and pulling device of claim 1, wherein said locking assembly comprises adjustable locking bolts configured to be axially moved into locking engagement with a building element in said drive stop.

7. The building element driving and pulling device of claim 1, wherein said slide hammer comprises an elongated drive body and a handle projecting out through said guide frame.

8. The building element driving and pulling device of claim 7, wherein said handle comprises a pair of handle portions projecting from said drive body.

9. The building element driving and pulling device of claim 8, wherein each of said handle portions comprises a substantially V-shaped rod having a first rod portion projecting radially from a first portion of said drive body and a second rod portion projecting at an angle from a second portion of said drive body.

10. A method of using the building element driving and pulling device of claim 1, comprising the steps of:
placing a portion of a building element comprising a solid rod or star picket into said receptacle of said drive stop;
manually sliding said slide hammer along said guide channel and engaging said drive stop and driving said building element into the ground or other material;
removing the building element driving and pulling device;
placing said portion of said building element into said receptacle;
adjusting said locking assembly and releasably locking said building element in said receptacle;
manually sliding said slide hammer along said guide channel and engaging said pull stop and pulling said building element out of the ground or other material; and
adjusting said locking assembly and releasing said building element from said receptacle.

13. A building element driving and pulling device comprising:
an elongated guide frame defining a guide channel, wherein said guide frame comprises a plurality of wire frame pieces disposed parallel to each other and spaced apart at intervals;
a drive stop disposed at a first end of said guide channel and a pull stop disposed at a second end of said guide channel, wherein said drive stop comprises a receptacle configured to receive a portion of a building element therein, wherein:
each of said drive stop and said pull stop comprises a strike face disposed to face toward one another,
each of said drive stop and said pull stop comprises a substantially cylindrical structure mounted to and within said guide frame,
said drive stop comprises at least one guide slot configured to receive and engage with at least one fin of a star picket;
a locking assembly configured to releasably lock a portion of a building element in said drive stop, wherein said locking assembly comprises adjustable locking bolts configured to be axially moved into locking engagement with a building element in said drive stop; and
a slide hammer disposed within said guide frame and manually slidable along said guide channel between said drive stop and said pull stop and to selectively engage said drive stop to drive a building element into a material and said pull stop to pull a building element out of a material, wherein:
said slide hammer comprises an elongated drive body and a handle projecting out through said guide frame,
said handle comprises a pair of handle portions projecting from said drive body,
each of said handle portions comprises a substantially V-shaped rod having a first rod portion projecting radially from a first portion of said drive body and a second rod portion projecting at an angle from a second portion of said drive body.
